(19) United States
(12) Patent Application Publication
(10) Pub. No.: US 2011/0116006 A1
(43) Pub. Date: May 19, 2011

(54) ILLUMINATION DEVICE AND LIQUID CRYSTAL DISPLAY DEVICE

(75) Inventors: Takeshi Masuda, Osaka-shi (JP); Yuhsaku Ajichi, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 12/996,841

(22) PCT Filed: May 29, 2009
(86) PCT No.: PCT/JP2009/059904

§ 371 Date: Dec. 8, 2010

(30) Foreign Application Priority Data
Aug. 7, 2008 (JP) 2008-204395

(51) Int. Cl. G02F 1/1335; F21V 8/00

(52) U.S. Cl. 349/61; 362/613

(57) ABSTRACT

A backlight (2) (illumination device) of this invention includes: a plurality of light sources (5), a plurality of light guide bodies (7) for causing surface emission of light emitted from the light sources; a diffusing plate (8) (flat plate) provided so as to face light-emitting surfaces (7a) of the light guide bodies (7) while maintaining a predetermined distance between the diffusing plate (8) and the respective light-emitting surfaces (7a). Maintaining sections (10) (distance maintaining sections) are provided between the respective light guide bodies (7) and the diffusing plate (8) and provided on the side of the diffusing plate (8), the maintaining sections (10) maintaining the predetermined distance between the diffusing plate (8) and the respective light-emitting surfaces (7a) of the respective light guide bodies (7).

### TECHNICAL FIELD

The present invention relates to an illumination device used as a backlight of a liquid crystal display device or the like, and also relates to a liquid crystal display device including the illumination device.

### BACKGROUND ART

Liquid crystal display devices have become rapidly popular in place of cathode ray tube (CRT) based display devices in recent years. The liquid crystal display devices have been in widespread use in liquid crystal televisions, monitors, mobile phones, and the like, which take advantage of energy saving, thin, and lightweight features and other features of the liquid crystal display devices. One of ways to further take advantage of such features is to improve an illumination device (i.e., a so-called backlight) which is provided behind the liquid crystal display device.

The illumination devices are roughly classified into a side light type (also referred to as an edge light type) and a direct type. The side light type is configured such that a light guide body is provided behind a liquid crystal display panel and a light source is provided at a lateral edge of the light guide body. Light emitted from the light source is reflected by the light guide body, so as to irradiate the liquid crystal display panel indirectly and uniformly. With this configuration, it is possible to realize an illumination device which has a reduced thickness and excellent luminance uniformity, although its luminance is low. For this reason, the side light type illumination device is mainly used in medium- to small-size liquid crystal displays such as a mobile phone and a laptop personal computer.

One example of the side light type illumination device is the one disclosed in Patent Literature 1. Patent Literature 1 discloses a surface-emitting device in which a reflecting surface of a light guide body is provided with a plurality of dots for the purpose of allowing for uniform light emission from a light-emitting surface. In this surface-emitting device, light is not transmitted to a corner section of the reflecting surface due to directivity of a light source, and thereby the corner section of the reflecting surface is darkened. In order to deal with this, the corner section has a higher dot-density compared with other sections.

The direct type illumination device is provided with a plurality of light sources aligned behind a liquid crystal display panel, so as to directly irradiate light onto the liquid crystal display panel. This makes it easier to obtain a high luminance even with a large screen. On this account, the direct type illumination device is mainly employed in a large liquid crystal display of 20 inch or more. However, a currently-available direct type illumination device has a thickness of as much as approximately 20 mm to approximately 40 mm, and this becomes an obstacle to a further reduction in a thickness of the display.

The further reduction in the thickness of the large liquid crystal display can be achieved by shortening a distance between the light source and the liquid crystal display panel. In this case, however, it is impossible for the illumination device to achieve luminance uniformity unless the number of light sources is increased. However, increasing the number of light sources increases a cost. In view of this, there is a need for developing an illumination device which is thin and has excellent luminance uniformity, without increasing the number of light sources.

Conventionally, in order to solve these problems, such an attempt has been conducted that a plurality of side light type illumination devices are aligned and thereby the thickness of the large liquid crystal display is reduced.

For example, Patent Literature 2 proposes a planar light source device that can secure a wide light-emitting area with a compact structure and therefore can be suitably used in a large liquid crystal display. This planar light source device has a tandem structure in which board-shaped light guide blocks are aligned tandemly and each of the light guide blocks is provided with a first light source for supplying each of the light guide blocks with first light.

An illumination device configured, as described above, such that a plurality of light-emitting units each of which is made by a combination of a light source and a light guide body are aligned is called a tandem type illumination device.

### CITATION LIST

Patent Literature 1

Japanese Patent Application Publication, Tokukai, No. 2003-43266 (Publication Date: Feb. 13, 2003)

Patent Literature 2

Japanese Patent Application Publication, Tokukaihei, No. 11-288611 (Publication Date: Oct. 19, 1999)

Patent Literature 3

Japanese Patent Application Publication, Tokukai, No. 2006-302687 (Publication Date: Nov. 2, 2006)

### SUMMARY OF INVENTION

However, in the illumination device configured by the combination of the light guide bodies and the light sources as described above, aligning the plurality of light guide bodies planerly arises such a problem that luminance still becomes non-uniform because of (i) luminance unevenness caused by joints between the light guide bodies and (ii) in-plane light non-uniformity occurring in light-emitting surfaces of the light guide bodies.

In order to deal with this, for example in the planar light source device disclosed in Patent Literature 2, a gap is provided between the light guide body and a diffusing plate. Light emitted from the light guide body reaches the diffusing plate while overlapping one another in multiple directions. Therefore, increasing a distance between the light guide body and the diffusing plate allows the light irradiated onto the diffusing plate to be averaged, thereby making it possible to reduce the above-mentioned luminance non-uniformity.

However, since the above configuration is such that the gap is simply provided between the light guide body and the diffusing plate, the light guide body and the diffusing plate are bent due to heat generated in the light source and a force applied externally. This causes the distance between the light guide plate and the diffusing plate non-constant, thereby impairing luminance uniformity.

In order to deal with this, for example, Patent Literature 3 discloses such a configuration that a protruding section is provided between a light guide body and a diffusing plate so that a distance between the two is maintained constant. This prevents the bending of the light guide body and therefore the distance is maintained constant, thereby making it possible to maintain luminance uniformity.

The protruding section disclosed in Patent Literature 3, however, is made only for the purpose of maintaining the distance between the light guide body and the diffusing plate constant, and is not made in consideration of a material of the protruding section and a position at which the protruding section is provided. In a case where the protruding section is formed on the light guide body without considering the material and the position, the following problem occurs: Light emitted from the light-emitting surface of the light guide body is reflected by the protruding section, thereby leading to luminance unevenness and causes non-uniform light emission. Using such an illumination device as a backlight in a display device impairs display quality.

Further, the protruding section disclosed in Patent Literature 3 is provided on the side of the light guide plate. This causes a bright dot because of the following reasons:

In general, a surface of the light guide plate has been subjected to fine processing for causing the surface of the light guide plate to function as a lens or a prism. This fine processing provides fine shapes, which give a light diffusing effect. In a case where the protruding section for maintaining the distance between the light guide body and the diffusing plate constant is formed on the light guide plate which has been subjected to such fine processing, light is diffused also by the protruding section. At this time, the amount of light diffused therein is large because the protruding section is far larger than the fine shapes such as the prism and the lens. As a result, the bright point occurs in the vicinity of the protruding section.

The present invention was made in view of the foregoing problems, and an objective of the present invention is to provide an illumination device which maintains a distance between a light guide body and a diffusing plate constant and further improves its luminance uniformity.

In order to attain the objective, an illumination device according to the present invention includes: a plurality of light sources; a plurality of light guide bodies for causing surface emission of light emitted from the light sources; a flat plate provided so as to face light-emitting surfaces of the respective plurality of light guide bodies while maintaining a predetermined distance between the flat plate and the respective light-emitting surfaces; and distance maintaining sections, provided between the respective plurality of light guide bodies and the flat plate and provided on the flat plate, for maintaining the predetermined distance between the flat plate and the respective light-emitting surfaces of the plurality of light guide bodies.

In general, the light guide body has a surface which has been subjected to fine processing for causing the surface of the light guide plate to function as a lens or a prism. Light transmitted inside the light guide body is diffused by fine shapes obtained by the fine processing and is taken out to the outside.

In the case where the distance maintaining section is provided on the flat plate, the distance maintaining section is separated from the light guide body. Therefore, in this case, light transmitted inside the light guide body is hardly subjected to a diffusing effect caused by the distance maintaining section.

Thus, according to the foregoing configuration, providing the distance maintaining section on the flat plate makes it possible to prevent light-emission luminance unevenness caused by a difference in size between (i) the fine processing applied on the light-emitting surface of the light guide body and (ii) the distance maintaining section.

Note that forming the distance maintaining section so that it has a small area contacting the light-emitting surface of the light guide body makes it possible to further reduce a diffusing effect on light transmitted inside the light guide body.

Further, according to this configuration, the distance maintaining section is provided on the flat plate, which has a simple shape, rather than on the light guide body, which has a complex shape. Therefore, this configuration achieves such an advantage that forming of each member is carried out more easily.

In the illumination device of the present invention, it is preferable that each of the distance maintaining sections is made from a material having a light-transmitting property and a light-diffusing property.

With this configuration, because the distance maintaining section is made from the material having the light-transmitting property and the light-diffusing property, it is possible to reduce the amount of light blocked by the distance maintaining section and the amount of light reflected by the distance maintaining section. In a case where the flat plate having the distance maintaining section made from the material having the light-transmitting property and the light-diffusing property is provided together with the light guide bodies, the distance maintaining section does not hinder traveling of light emitted from the light-emitting surface, regardless of where in a light-emitting surface the distance maintaining section is provided, the light-emitting surface being formed by a combination of the light-emitting surfaces of the plurality of light guide bodies. This makes it possible to prevent a reduction in luminance uniformity.

The illumination device of the present invention may include a plurality of diffusing means for diffusing light, said plurality of diffusing means being provided on the flat plate and in the vicinity of areas where the respective distance maintaining sections are provided.

With this configuration, because the diffusing means is provided, it is possible to prevent occurrence of luminance unevenness caused by the presence of the distance maintaining section and thereby to further reduce the luminance unevenness as a whole. Therefore, in the case where the distance maintaining section is provided on the flat plate provided so as to face the light guide body, it is not necessary to exactly define a position of the distance maintaining section relative to the light guide body. Therefore, even in a case where the flat plate is provided in such a manner that the flat plate is slightly shifted relative to the light guide body, it is possible to maintain luminance uniformity.

In the illumination device of the present invention, it is more preferable that the flat plate is a diffusing plate for diffusing light emitted from the plurality of light sources.

With this configuration, because the light emitted from the plurality of light sources can be diffused and irradiated onto an irradiation object, it is possible to further improve luminance uniformity.

In the illumination device of the present invention, the flat plate may be a transparent plate through which light emitted from the plurality of light sources is transmitted.

In the illumination device of the present invention, the distance maintaining sections may be formed so as to be integrated with the flat plate.

In the illumination device of the present invention, each of the distance maintaining sections may have an insertion section which is inserted into a hole of the flat plate. With this configuration, it is possible to form the flat plate and the distance maintaining section such that they are separated from each other.

In the illumination device of the present invention, the flat plate may have a surface which is partially subjected to fine processing so that the plurality of diffusing means may be realized.

In the illumination device of the present invention, each of the distance maintaining sections may be provided in a region of a corresponding one of the light-emitting surfaces in which region a smaller amount of light reaches from a corresponding one of the plurality of the light sources.

Here, the region in which the smaller amount of light reaches from the corresponding one of the plurality of light sources refers to a region in which the amount of light emission is smaller than an average amount of light emission per unit area of the light-emitting surface of one light guide body. In a case of a tandem-type light guide body, the above-mentioned “region in which the smaller amount of light reaches from the corresponding one of the plurality of light sources” specifically refers to an end section (a dark section 7g in FIG. 2) in the light-emitting surface of the corresponding one of the light guide bodies, the end section being on the side which is the closest to the light source.

With this configuration, it is possible to further improve luminance uniformity of the illumination device.

Further, a liquid crystal display device according to the present invention includes any one of the foregoing illumination devices as a backlight.

With this configuration, by including the illumination device according to the present invention, it is possible to realize a liquid crystal display device having excellent luminance uniformity.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a cross-section view schematically illustrating a configuration of a liquid crystal display device according to one embodiment of the present invention.

FIG. 2

FIG. 2 is a perspective view schematically illustrating a configuration of a light guide body unit provided in a liquid crystal display device.

FIG. 3

FIG. 3 is a view schematically illustrating a traveling direction of light emitted from a light-emitting surface of the light guide body illustrated in FIG. 2.

FIG. 4

FIG. 4 is a view schematically illustrating a traveling direction of light emitted from a light-emitting surface of a light guide body illustrated in FIG. 1.

FIG. 5

FIG. 5 is a view illustrating one example of a shape of a maintaining section.

FIG. 6

FIG. 6 is a view illustrating one example of a shape of a maintaining section. (a) of FIG. 6 shows the maintaining section which has been attached to a diffusing plate, whereas (b) of FIG. 6 shows the maintaining section which is not attached to the diffusing plate yet.

FIG. 7

FIG. 7 is a cross-section view schematically illustrating a configuration of a liquid crystal display device according to another embodiment of the present invention.

FIG. 8

FIG. 8 is a cross-section view schematically illustrating a configuration of a liquid crystal display device according to further another embodiment of the present invention.

FIG. 9

FIG. 9 is a cross-section view schematically illustrating a configuration of a liquid crystal display device according to still further another embodiment of the present invention.

FIG. 10

FIG. 10 is a cross-section view schematically illustrating a configuration of a liquid crystal display device according to yet another embodiment of the present invention.

### DESCRIPTION OF EMBODIMENTS

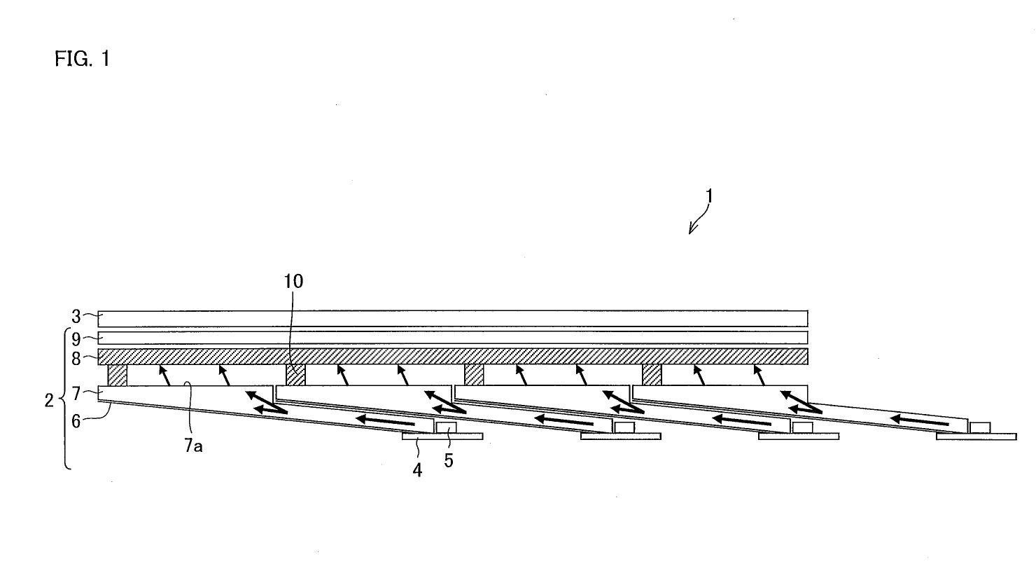

One embodiment of the present invention is described below with reference to FIG. 1 through FIG. 6. Note that the present invention is not limited to this.

The present embodiment describes an illumination device used as a backlight of a liquid crystal display device.

FIG. 1 is a cross-section view schematically illustrating a configuration of a liquid crystal display device 1 according to the present embodiment. The liquid crystal display device 1 includes a backlight 2 (illumination device) and a liquid crystal display panel 3 provided so as to face the backlight 2.

The liquid crystal display panel 3 is similar to a generally-used liquid crystal display panel used in a conventional liquid crystal display device. For example, the liquid crystal display panel 3 is configured so as to include: an active matrix substrate on which a plurality of TFTs (thin film transistors) are formed; and a CF substrate facing the active matrix substrate, and further to include a liquid crystal layer sealed between the active matrix substrate and the CF substrate by means of a sealing material, although they are not illustrated.

A configuration of the backlight 2 provided in the liquid crystal display device 1 is described in detail below.

The backlight 2 is provided behind the liquid crystal display panel 3 (on an opposite side of a display surface). As shown in FIG. 1, the backlight 2 includes a substrate 4, a light source 5, a reflecting sheet 6, a light guide body 7, a diffusing plate 8 (flat plate), an optical sheet 9, and a maintaining section 10 (distance maintaining section).

The light source 5 is, for example, a side light-emitting type light-emitting diode (LED) or a cold cathode fluorescent tube (CCFL). Description herein deals with, as one example, an LED as the light source 5. By using, as the light source 5, the side light-emitting type LED including chips of R, G, and B molded into one package, it is possible to achieve an illumination device capable of a wide range of color reproduction. Note that the light source 5 is provided on the substrate 4.

The light guide body 7 causes surface emission of light from a light-emitting surface 7a, the light having been emitted from the light source 5. The light-emitting surface 7a is a surface for emitting light toward an irradiation object. In the present embodiment, the light guide bodies 7 employ a tandem configuration as shown in FIG. 1. That is, the light guide bodies 7 are arranged such that: (i) each light guide body 7 includes (a) a light-emitting section 7b including the light-emitting surface 7a and (b) a light guide section 7c for directing, to the light-emitting section 7b, light emitted from the light source 5; (ii) the light-emitting section 7b and the light guide section 7c have different thicknesses at least at a connection therebetween; and (iii) the light-emitting section 7b of one light guide body 7 is placed on the light guide section 7c of another light guide body 7. Thereby, a flush light-emitting surface is formed by a plurality of light guide bodies.

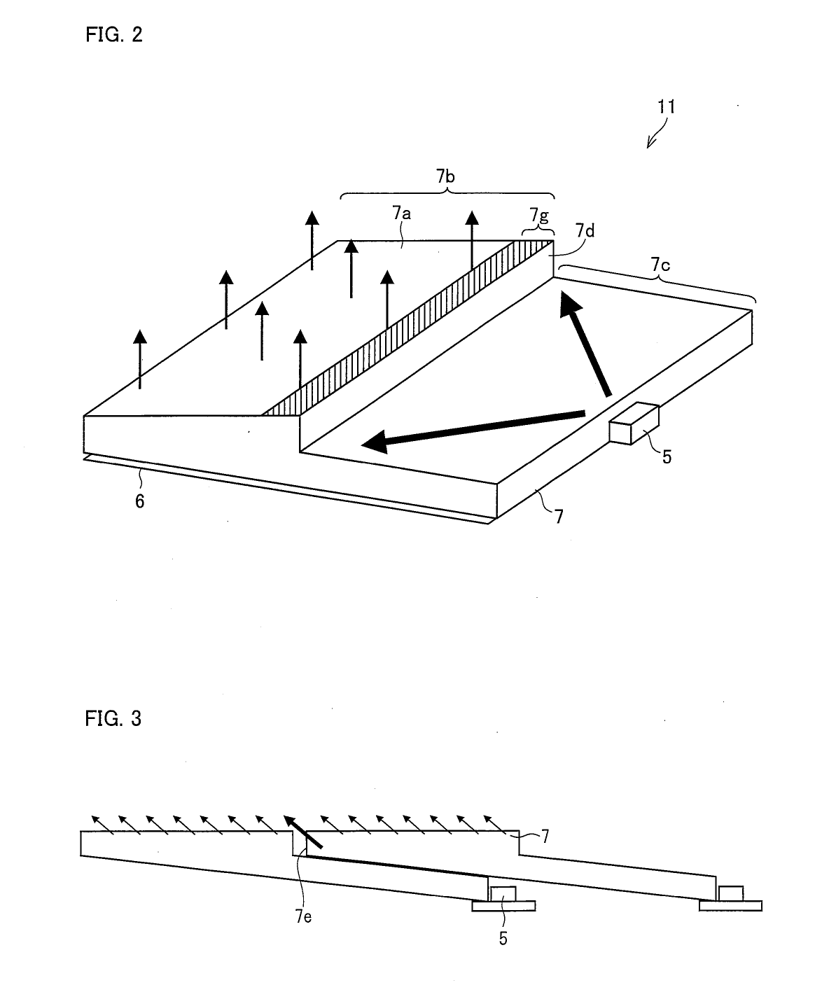

FIG. 2 is a perspective view schematically illustrating a configuration of a light guide body unit 11 included in the liquid crystal display device 1 shown in FIG. 1. The light guide body unit 11 diffuses light emitted from the light source 5 for the purpose of emitting, in a form of plane emission, the light. The light guide body unit 11 includes the light source 5, the substrate 4 (FIG. 1), the reflecting sheet 6, and the light guide body 7. As shown in FIG. 2, light emitted from the light source 5 enters the light guide section 7c of the light guide body 7, is transmitted through the light guide section 7c, and then reaches the light-emitting section 7b. A surface (light-emitting surface 7a) or a back surface of the light-emitting section 7b of the light guide body 7 has been subjected to a process (fine recesses and projections processing) or a treatment each of which is for causing light which has been guided thereto to be emitted toward a front surface, although they are not illustrated. Whereby, the light is emitted from the light-emitting surface 7a of the light guide body 7 toward the liquid crystal display panel 3. Examples of a specific method for the process or the treatment applied to the light-emitting section 7b of the light guide body 7 encompass prism processing, texturing, and print processing. However, this method is not particularly limited, and may use a publicly-known method as needed.

Further, the light guide body 7 is mainly made from a transparent resin such as a PMMA or a polycarbonate. However, the material is not particularly limited, but may preferably be a material having a high light transmittance.

Furthermore, the light guide body 7 may be formed by means of, for example, injection molding or extrusion molding, hot-press molding, or cutting. However, the present invention is not particularly limited to these forming methods, and may use any processing method as long as it provides a similar property.

The reflecting sheet 6 is provided so as to touch the back surface (a surface opposite to the light-emitting surface 7a) of the light guide body 7. The reflecting sheet 6 reflects light so as to allow the light-emitting surface 7a to emit a larger amount of light.

The diffusing plate 8 is provided so as to face the light-emitting surface 7a, while covering the whole of the flush light-emitting surface formed by the light-emitting surfaces 7a of the light guide bodies 7 and maintaining a predetermined distance from the light-emitting surfaces 7a. The diffusing plate 8 diffuses light emitted from the light-emitting surface 7a of the light guide body 7 so that the light is irradiated onto the optical sheet 9 (described later). The present embodiment uses, as the diffusing plate 8, “SUMIPEX E RMA10” (manufactured by Sumitomo Chemical Co., Ltd.) having a thickness of 2.0 mm. Further, the above-mentioned predetermined distance is set to 3.0 mm.

The maintaining section 10 maintains the distance between the light-emitting surface 7a of the light guide body 7 and the diffusing plate 8 constant. In the present embodiment, a height of the maintaining section 10 is set to 3.0 mm so that the foregoing predetermined distance is set to 3.0 mm. Note that the maintaining section 10 may preferably be made from a resin such as a polycarbonate, as well as the light guide body 7 and the diffusing plate 8. Further, a shape of the maintaining section 10 is not particularly limited, however, the maintaining section 10 has a prismatic shape in the present embodiment. A more specific configuration of the maintaining section 10 will be described later.

The optical sheet 9 is made of a plurality of sheets stacked on the side of the front surface of the light guide body 7. The optical sheet 9 uniforms and focuses light emitted from the light-emitting surface 7a of the light guide body 7 so as to emit the light toward the liquid crystal display panel 3. That is, the followings may be applied to the optical sheet 9: a diffusing sheet for diffusing light while focusing the light; a lens sheet for focusing light so as to improve luminance in a front direction (a direction toward the liquid crystal display panel 3); or a polarizing and reflecting sheet for reflecting a polarizing component of light and transmitting another polarizing component so as to improve luminance of the liquid crystal display device 1. It is preferable that these are used in combination as needed according to a price or a performance of the liquid crystal display device 1. In the present embodiment, as one example, “LIGHT-UP 250GM2” (manufactured by Kimoto Co., Ltd.) and/or the like is used as the diffusing sheet, “Thick RBEF” (manufactured by Sumitomo 3M Ltd.) and/or the like is used as a prism sheet (lens sheet), and “DBEF-D400” (manufactured by Sumitomo 3M Ltd.) and/or the like is used as a polarizing sheet (polarizing and reflecting sheet).

With the foregoing configuration of each member, light emitted from the light source 5 is transmitted through the light guide body 7 while being subjected to a scattering effect and a reflecting effect as shown in FIG. 2, and is emitted from the light-emitting surface 7a. Then, the light goes through the diffusing plate 8 and the optical sheet 9, so as to reach the liquid crystal display panel 3.

(Luminance Uniformity)

Here, a principle that luminance becomes non-uniform is described below with reference to FIG. 2 and FIG. 3.

FIG. 2 illustrates how light emitted from the light source 5 is transmitted through the light guide body 7. As shown in FIG. 2, the light emitted from the light source 5 enters the light guide section 7c of the light guide body 7 at a certain critical angle. The light which has entered the light guide section 7c radially diffuses inside the light guide section 7c, and then reaches the light-emitting section 7b. Then, the light is reflected by the reflecting sheet 6 provided on the back surface of the light-emitting section 7b, thereby being emitted from the light-emitting surface 7a. In general, there is such a tendency that the amount of light is reduced as light goes far from the light source 5. Therefore, a region in the light guide body 7 which region is on the side far from the light source 5 has a smaller amount of light than other regions.

Further, a step section 7d is formed at a boundary region between the light guide section 7c and the light-emitting section 7b in the light guide body 7, because the light guide section 7c and the light-emitting section 7b have different thicknesses. This forms a dark section 7g (a shaded area in FIG. 2; a dead space) in the light-emitting surface 7a, the dark section 7g being an area where light is difficult to reach. Therefore, the dark section 7g region also has a smaller amount of light. Thus, the amount of light varies depending on a position in the light-emitting surface 7a. This causes non-uniform luminance.

Further, in a case of the backlight having the tandem configuration as in the present embodiment, luminance unevenness occurs due to a joint between the light guide bodies 7. Specifically, in the tandem configuration, the light-emitting section 7b of the light guide body 7 is often manufactured so as to have a length with a minus tolerance. This is for the purpose of preventing one light guide body 7 from being placed on another light guide body 7 to an excess degree when these light guide bodies 7 are overlapped with each other. This creates a gap corresponding to the tolerance at a joint between one light guide body and another light guide body, as shown in FIG. 3. Therefore, light emitted from an end surface (7e) which is on the side far from a light source of said another light guide body is divided into: light entering said one light guide body; and light (indicated by the bold arrow in FIG. 3) traveling upward without entering said one light guide plate. Such light emitted from the end surface (7e), which is not the light-emitting surface, has a high luminance because such light has a higher light intensity than light emitted from the light-emitting surface, as described above. Therefore, the light traveling upward from the end surface (7e) appears as a bright line, thereby giving a great effect on luminance unevenness.

Thus, due to the configuration specific to the light guide body 7, luminance uniformity is impaired. In order to overcome the luminance non-uniformity, conventionally, the following method has been conducted: A maintaining section is provided between the light-emitting surface 7a and the diffusing plate 8 which maintaining section maintains a constant distance between the two. Thereby, light emitted from the light-emitting surface 7a is diffused and thereby is averaged.

Providing the maintaining section and thereby increasing the distance between the light-emitting surface 7a and the diffusing plate 8 enables light emitted from the light-emitting surface 7a to be irradiated onto the diffusing plate 8 uniformly. The conventional maintaining section, however, is provided on the light-emitting surface 7a of the light guide body 7, as disclosed in Patent Literature 3. This causes a bright dot in the vicinity of the maintaining section. This arises such a problem that luminance changes in an area where the maintaining section is provided and thereby luminance unevenness occurs. Further, the light guide body 7 has a more complex shape than the diffusing plate 8, which is shaped in a flat plate. This arises such a problem that forming the maintaining section on the light guide body 7 makes the forming more complex.

(Configuration of Maintaining Section 10)

In view of this, in the present embodiment, the maintaining section 10 is provided on the side of the diffusing plate 8 which is provided so as to face the light-emitting surface formed by the plurality of light guide bodies 7, for the purpose of maintaining the distance between the light-emitting surface 7a and the diffusing plate 8 at a predetermined value, as shown in FIG. 1.

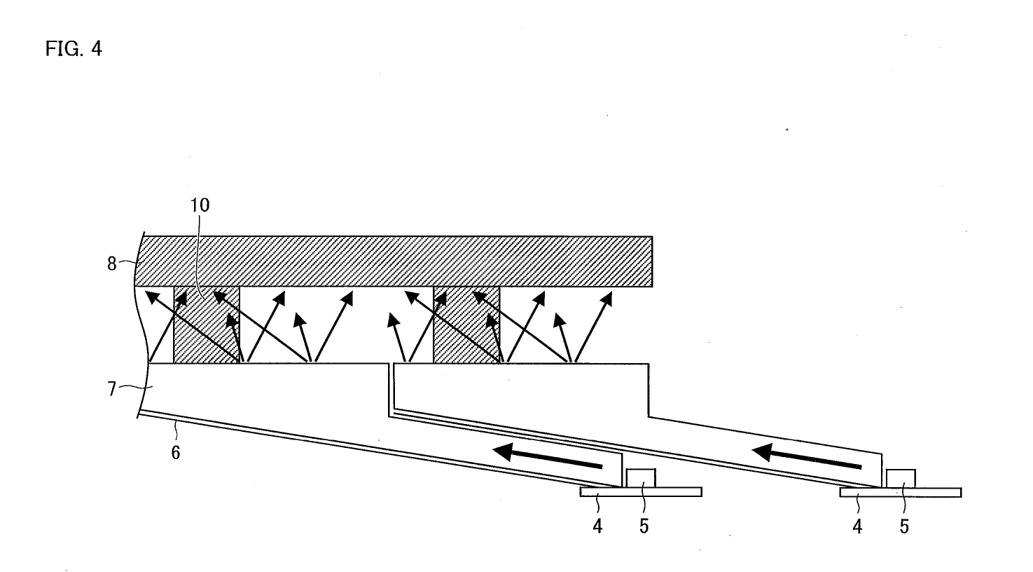

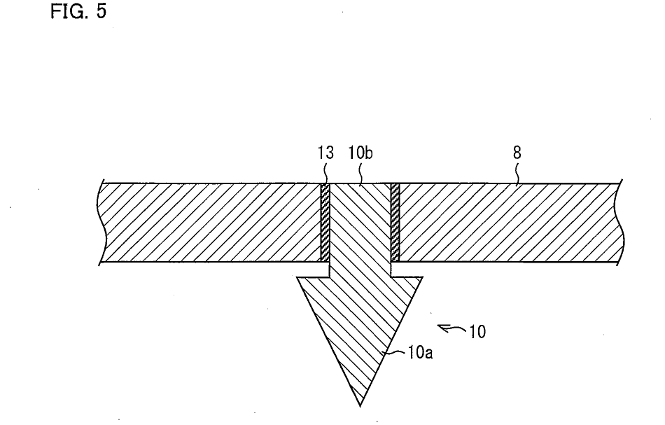

FIG. 4 is a view schematically illustrating a traveling direction of light emitted from the light-emitting surface 7a in the backlight 2 of the present embodiment. FIG. 4 shows part of the backlight 2. As show in FIG. 4, by providing the maintaining section 10 and thereby increasing the distance between the light-emitting surface 7a and the diffusing plate 8, it is possible to uniformly irradiate, onto the diffusing plate 8, light emitted from the light-emitting surface 7a.

Here, in order to further improve luminance uniformity, it is preferable that the maintaining section 10 is provided in a region (the dark section 7g in FIG. 2) of the light-emitting surface 7a in which region a small amount of light reaches from the light source. In other words, the region in which the small amount of light reaches from the light source is a region where the amount of light emission per unit area is smaller than that in other regions of the light-emitting surface 7a.

With this, it is possible to reduce a percentage of light affected by the maintaining section 10, specifically, a percentage of light reflected by the maintaining section 10. However, in a case where the maintaining section 10 is formed on the side of the diffusing plate 8, if the diffusing plate 8 is provided in such a manner that the diffusing plate 8 is shifted relative to the light guide body 7, the position of the maintaining section 10 may be shifted from the dark section 7g in the light-emitting surface 7a.

In order to deal with this, in the present embodiment, the maintaining section 10 is made from a material having a light-transmitting property and a light-diffusing property, for the purpose of preventing light from being blocked by or reflected by the maintaining section 10. Thus, by making the maintaining section 10 from the material having the light-transmitting property and the light-diffusing property, the following effect is achieved: In a case where the diffusing plate 8 on which the maintaining section 10 is formed is provided so as to face the light guide bodies 7, the maintaining section 10 does not hinder traveling of light emitted from the light-emitting surfaces, regardless of where in the light-emitting surface the maintaining section 10 is provided, the light-emitting surface being formed by the combination of the light-emitting surfaces 7a of the plurality of light guide bodies 7. This makes it possible to prevent a reduction in luminance uniformity. That is, even in a case where the diffusing plate 8 is provided in such a manner that the diffusing plate 8 is slightly shifted relative to the light guide body 7, the possibility that the maintaining section 10 affects the amount of light emitted from the light-emitting surface is reduced, and therefore it is possible to prevent a reduction in luminance uniformity which reduction is caused by the shifting of the position.

As shown in FIG. 1, in the liquid crystal display device 1, the maintaining section 10 is provided in the vicinity of the end section in the light-emitting surface 7a of each of the light guide bodies 7, the end section being on the side which is far from the light source 5. However, this is merely one example, and the present invention is not limited to this arrangement.

Note that examples of the foregoing “material having the light-transmitting property and the light-diffusing property” encompass a transparent resin (e.g., an acrylic or a polycarbonate) mixed with particles made from a material (e.g., a titanium oxide or a barium sulfate) having a light-diffusing property.

The maintaining section 10 may be formed so as to be integrated with the diffusing plate 8. Further, instead of this, the maintaining section 10 may be manufactured as a member separated from the diffusing plate 8 and may be mounted on the diffusing plate 8. Further, in the backlight 2 shown in FIG. 1, the maintaining section 10 has a prismatic shape, however, the present invention is not limited to this shape.

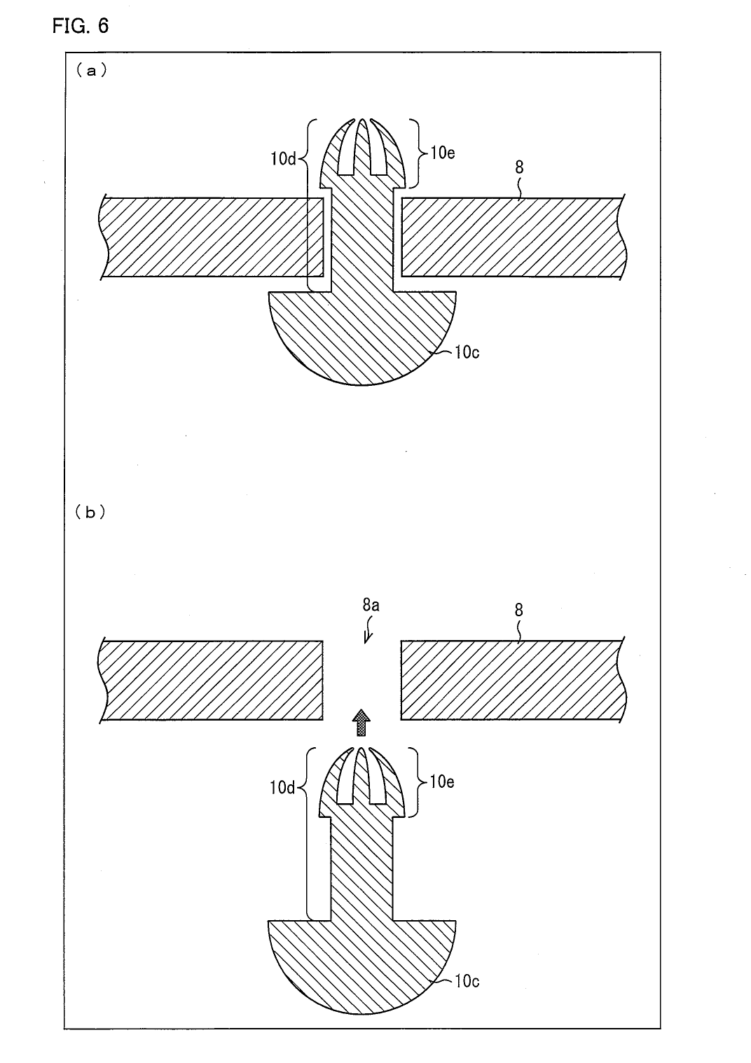

FIG. 5 and (a) and (b) of FIG. 6 illustrate examples of maintaining sections 10 having another shapes. Each of the maintaining sections illustrated therein is manufactured as a member separated from the diffusing plate 8 and thereafter is fixed to the diffusing plate.

A maintaining section 10 shown in FIG. 5 includes a projection 10a shaped in a circular cone and an insertion section 10b. This maintaining section 10 is configured such that the insertion section 10b is inserted into a hole of a diffusing plate 8 and is adhered and fixed thereto by means of an adhesive agent 13.

A maintaining section 10 shown in (a) of FIG. 6 includes a projection 10c shaped in a semisphere and an insertion section 10d. In this maintaining section 10, as shown in (b) of FIG. 6, the insertion section 10d is inserted, in a direction indicated by the arrow, into a hole 8a of a diffusing plate 8, and a portion 10e of the insertion section 10d exposes from an opposite surface of the diffusing plate 8. Thereby, the insertion section 10d is attached and fixed.

A clearance between the maintaining sections 10 is not particularly limited. In a case where the backlight is used in a general, home-use liquid crystal display device (e.g., an approximately 30-inch), the clearance between the maintaining sections 10 may be tens cm both lengthwise and crosswise.

In the present embodiment, by providing, on the diffusing plate 8, the maintaining section 10 having the foregoing configuration, it is possible to prevent unevenness of light-emission luminance caused by a difference in size between (i) the fine recesses and projections processing (fine processing) applied on the light-emitting surface 7a of the light guide body 7 and (ii) the maintaining section 10. Further, according to the foregoing configuration, the maintaining section 10 is provided on the side of the diffusing plate 8 having a simple shape, rather than on the side of the light guide body 7 having a complex shape. This provides such an advantage that the forming of the members can be carried out more easily.

As described above, because the liquid crystal display device 1 of the present embodiment includes the backlight 2 as described above, this liquid crystal display device 1 can emit more uniform light to the liquid crystal display panel 3, thereby improving display quality.

Further, because the illumination device of the present invention has excellent luminance uniformity even in a case where its light-emitting area is large, it is particularly preferable that this illumination device is used as a backlight of a liquid crystal display device having a large screen. However, the present invention is not limited to this, and may be used as a backlight of any liquid crystal display panel.

(Variation 1)

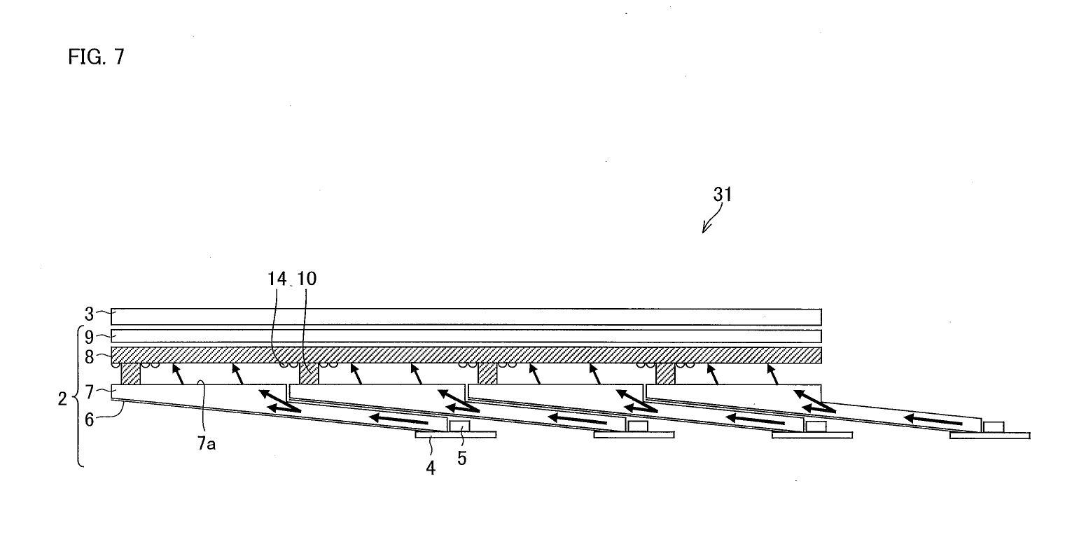

Next, a variation 1 of the present invention will be described with reference to FIG. 7. The description herein deals with only differences between the foregoing embodiment and the present variation. For convenience of explanation, in FIG. 7, members having the same configurations as those of the liquid crystal display device 1 shown in FIG. 1 are given the same names and the same signs as FIG. 1.

In addition to the configuration of the backlight 2 of the liquid crystal display device 1 shown in FIG. 1, a backlight 2 of a liquid crystal display device 31 shown in FIG. 7 has the following configuration: Fine processing 14 (diffusing means) for diffusing light has been applied on a surface of a diffusing plate 8 which surface faces a light-emitting surface 7a, and in the vicinity of a maintaining section 10. This fine processing refers to a roughing process for roughening the surface of the diffusing plate 8, for example, by forming small recesses and projections on the surface.

With this configuration, it is possible to prevent luminance unevenness occurring due to the presence of the maintaining section 10 and thereby to further reduce luminance unevenness in the whole area of the light-emitting surface. This eliminates a need for exactly defining a position of the maintaining section 10 relative to the light guide body 7, in a case where the maintaining section 10 is provided on the side of the diffusing plate 8 facing the light guide body 7. Therefore, it is possible to maintain luminance uniformity even in a case where the diffusing plate 8 is provided in such a manner that the diffusing plate 8 is slightly shifted relative to the light guide body 7.

Here, “the vicinity of the maintaining section 10”, in which the fine processing 14 is applied, refers to such a region that, in a case where the maintaining section 10 is provided therein, a difference in light emission luminance occurs between this region and the other regions.

In the variation 1, as a more preferable example of the present invention, such a configuration is described that the distance maintaining section formed on the diffusing plate is made from the material having the light-transmitting property and the light-diffusing property and the diffusing means (specifically, the fine processing) is applied in the vicinity of the distance maintaining section. However, the present invention is not limited to this configuration. The present invention only needs to have at least either one of (i) the configuration in which the distance maintaining section is made from the material having the light-transmitting property and the light-diffusing property and (ii) the configuration in which the diffusing means is provided in the vicinity of the distance maintaining section. However, note that having both of these configurations further improves luminance uniformity of a backlight.

(Variation 2)

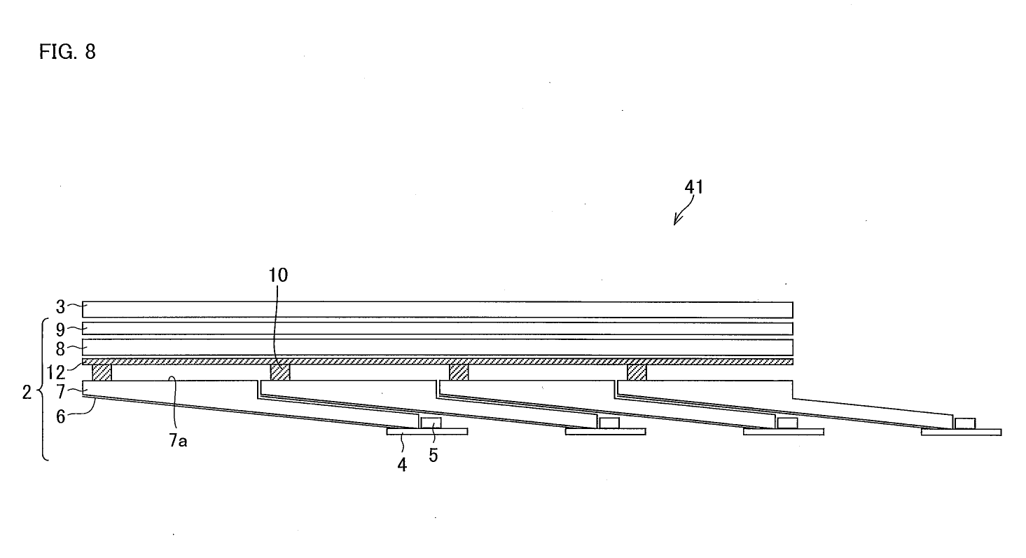

Next, a variation 2 of the present invention is described with reference to FIG. 8. The description herein deals with only differences between the foregoing embodiment and the present variation. For convenience of explanation, in FIG. 8, members having the same configurations as those of the liquid crystal display device 1 shown in FIG. 1 are given the same names and the same signs as FIG. 1.

In addition to the configuration of the backlight 2 of the liquid crystal display device 1 shown in FIG. 1, a backlight 2 of a liquid crystal display device 41 shown in FIG. 8 has the following configuration: A transparent plate 12 (flat plate) is further provided between a diffusing plate 8 and a light guide body 7. Further, the transparent plate 12 is provided with a maintaining section 10 (distance maintaining section) for maintaining a distance between a light-emitting surface 7a of the light guide body 7 and the transparent plate 12 constant. A specific configuration of the maintaining section 10 may employ the configuration described in the foregoing embodiment. Therefore, explanations thereof are omitted here.

Since the variation 2 further includes the transparent plate 12 between the diffusing plate 8 and the light guide body 7, a distance equivalent to a thickness of the transparent plate 12 is maintained between the maintaining section 10 and the diffusing plate 8. This makes it possible to prevent luminance unevenness occurring due to the presence of the maintaining section 10.

(Variation 3)

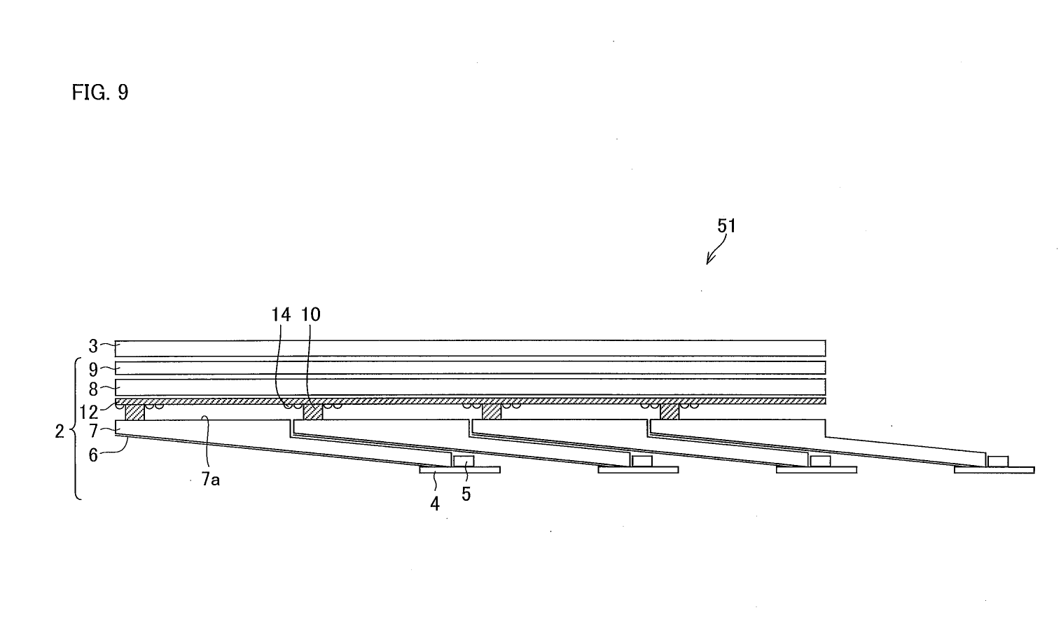

Next, a variation 3 of the present invention is described with reference to FIG. 9. The description herein deals with only differences between the foregoing embodiment and the present variation. For convenience of explanation, in FIG. 9, members having the same configurations as those of the liquid crystal display device 1 shown in FIG. 1 are given the same names and the same signs as FIG. 1.

In addition to the configuration of the backlight 2 of the liquid crystal display device 1 shown in FIG. 1, a backlight 2 of a liquid crystal display device 51 shown in FIG. 9 has the following configuration: A transparent plate 12 (flat plate) is further provided between a diffusing plate 8 and a light guide body 7. Further, the transparent plate 12 is provided with a maintaining section 10 (distance maintaining section) for maintaining a distance between a light-emitting surface 7a of the light guide body 7 and the transparent plate 12 constant. A specific configuration of the maintaining section 10 may employ the configuration described in the foregoing embodiment. Therefore, explanations thereof are omitted here.

Furthermore, fine processing 14 (diffusing means) for diffusing light is applied on a surface of the transparent plate 12 which surface faces the light-emitting surface 7a, and in the vicinity of the maintaining section 10. This fine processing refers to a roughing process for roughening the surface of the transparent plate 12, for example, by forming small recesses and projections on the surface.

In the variation 3, as a more preferable example of the present invention, such a configuration is described that the distance maintaining section formed on the transparent plate is made from the material having the light-transmitting property and the light-diffusing property and the diffusing means (specifically, the fine processing) is applied in the vicinity of the distance maintaining section. However, the present invention is not limited to this configuration. The present invention only needs to have at least either one of (i) the configuration in which the distance maintaining section is made from the material having the light-transmitting property and the light-diffusing property and (ii) the configuration in which the diffusing means is provided in the vicinity of the distance maintaining section. However, note that having both of these configurations further improves luminance uniformity of a backlight.

(Variation 4)

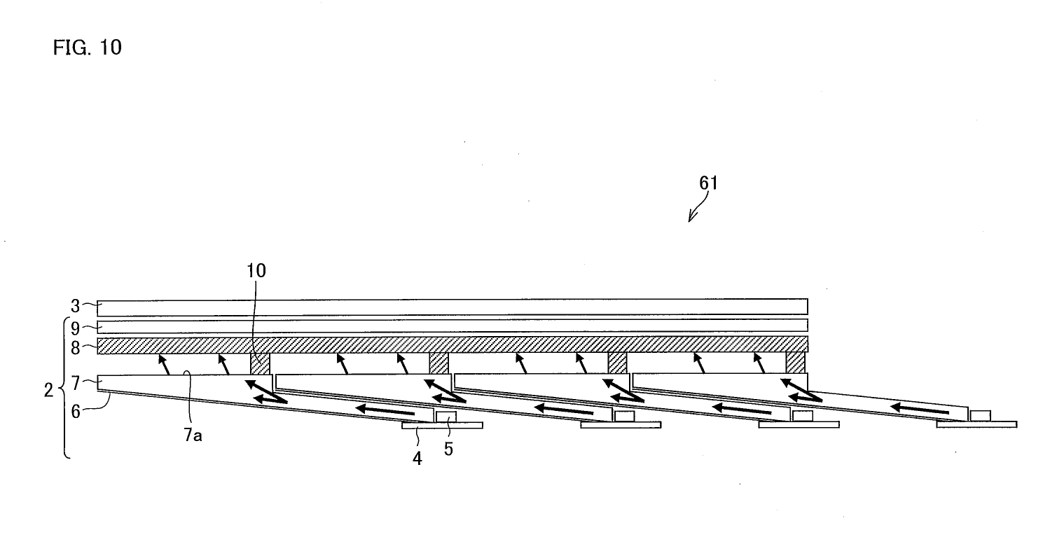

Next, a variation 4 of the present invention is described with reference to FIG. 10. The description herein deals with only differences between the foregoing embodiment and the present variation. For convenience of explanation, in FIG. 10, members having the same configurations as those of the liquid crystal display device 1 shown in FIG. 1 are given the same names and the same signs as FIG. 1.

In a liquid crystal display device 61 shown in FIG. 10, a maintaining section 10 (distance maintaining section) is provided in a region (i.e., a dark section 7g in the light-emitting surface 7a) of a light-emitting surface 7a of a light guide body 7 in which region a smaller amount of light reaches from a light source 5. In other words, a position of a diffusing plate 8 and a position of the maintaining section 10 are adjusted so that, in a case where a plurality of light guide bodies 7 are aligned tandemly and the diffusing plate 8 (flat plate) is mounted above the light guide bodies, the maintaining section 10 provided on the diffusing plate 8 is positioned in the dark section 7g in the light-emitting surface 7a of the light guide body 7. A specific configuration of the maintaining section 10 may employ the configuration described in the foregoing embodiment. Therefore, explanations thereof are omitted here.

According to this configuration of the variation 4, by providing the maintaining section 10 in a region in which a smaller amount of light reaches from the light source, it is possible to reduce a percentage of light affected by the maintaining section 10. This makes it possible to further improve luminance uniformity of the illumination device.

The present invention is not limited to the embodiment and the variations above, but may be altered by a skilled person within the scope of the claims. An embodiment based on a proper combination of technical means disclosed in the embodiment and the variations is encompassed in the technical scope of the present invention.

An illumination device of the present invention includes distance maintaining sections, provided between a respective plurality of light guide bodies and a flat plate and provided on the flat plate, for maintaining a predetermined distance between the flat plate and respective light-emitting surfaces of the plurality of light guide bodies, the distance maintaining sections being made from a material having a light-transmitting property and a light-diffusing property.

Further, an illumination device of the present invention includes: distance maintaining sections, provided between a respective plurality of light guide bodies and a flat plate and provided on the flat plate, for maintaining a predetermined distance between the flat plate and respective light-emitting surfaces of the plurality of light guide bodies; and a plurality of diffusing means for further diffusing light, said plurality of diffusing means being provided on the flat plate and in the vicinity of areas where the respective distance maintaining sections are provided.

Thus, according to the present invention, it is possible to realize an illumination device capable of maintaining a distance between a light guide body and a diffusing plate constant and further improving its luminance evenness.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

An illumination device according to the present invention may be used as a backlight of a liquid crystal display device. Particularly, the illumination device according to the present invention may preferably be used as a backlight of a large liquid crystal display device.

### REFERENCE SIGNS LIST

1 Liquid crystal display device
2 Backlight (Illumination device)
3 Liquid crystal display panel
4 Substrate
5 Light source (LED, Cold cathode fluorescent tube)
6 Reflecting sheet
7 Light guide body
7a Light-emitting surface (of light guide body)
7b Light-emitting section
7c Light guide section
8 Diffusing plate
9 Optical sheet
10 Maintaining section (Distance maintaining section)
11 Light guide body unit
12 Transparent plate
14 Fine processing (Diffusing means)
31 Liquid crystal display device
41 Liquid crystal display device
51 Liquid crystal display device
61 Liquid crystal display device

1. An illumination device, comprising:
a plurality of light sources;
a plurality of light guide bodies for causing surface emission of light emitted from the light sources;
a flat plate provided so as to face light-emitting surfaces of the respective plurality of light guide bodies while maintaining a predetermined distance between the flat plate and the respective light-emitting surfaces; and
distance maintaining sections, provided between the respective plurality of light guide bodies and the flat plate and provided on the flat plate, for maintaining the predetermined distance between the flat plate and the respective light-emitting surfaces of the plurality of light guide bodies.

2. The illumination device as set forth in claim 1, wherein:
each of the distance maintaining sections is made from a material having a light-transmitting property and a light-diffusing property.

3. The illumination device as set forth in claim 1, further comprising:
a plurality of diffusing means for diffusing light, said plurality of diffusing means being provided on the flat plate and in the vicinity of areas where the respective distance maintaining sections are provided.

4. The illumination device as set forth in claim 1, wherein:
the flat plate is a diffusing plate for diffusing light emitted from the plurality of light sources.

5. The illumination device as set forth in claim 1, wherein:
the flat plate is a transparent plate through which light emitted from the plurality of light sources is transmitted.

6. The illumination device as set forth in claim 1, wherein:
the distance maintaining sections are formed so as to be integrated with the flat plate.

7. The illumination device as set forth in claim 1, wherein:
each of the distance maintaining sections has an insertion section which is inserted into a hole of the flat plate.

8. The illumination device as set forth in claim 3, wherein:
the flat plate has a surface which is partially subjected to fine processing so that the plurality of diffusing means are realized.

9. The illumination device as set forth in claim 1, wherein:
each of the distance maintaining sections is provided in a region of a corresponding one of the light-emitting surfaces in which region a smaller amount of light reaches from a corresponding one of the plurality of the light sources.

10. A liquid crystal display device comprising, as a backlight, an illumination device as set forth in claim 1.
